(19) United States
(12) Patent Application Publication
(10) Pub. No.: US 2024/0200253 A1
(43) Pub. Date: Jun. 20, 2024

(54) STICKY WIPE CLOTH STRUCTURE

(71) Applicant: CHIH-PING WEI, TAINAN CITY (TW)

(72) Inventor: CHIH-PING WEI, TAINAN CITY (TW)

(21) Appl. No.: 18/295,365

(22) Filed: Apr. 4, 2023

(30) Foreign Application Priority Data
Dec. 20, 2022 (TW) 111214080

(51) Int. Cl. D06B 11/00

(52) U.S. Cl. CPC D06B 11/0059; D06B 3/10; D06M 2200/00; D10B 2401/16

(57) ABSTRACT

The present invention relates to a sticky wipe cloth structure, which mainly comprises a cloth layer and an acrylate polymer adhesive layer, wherein the acrylate polymer adhesive layer is an adhesive layer that penetrates into fibers of the cloth layer and forms on a surface of the cloth layer. Through the sticky acrylate polymer adhesive layer on the sticky wipe cloth, the dust, particles . . . and other dirt attached to the surface of the object can be wiped and removed to ensure that the surface of the object is not damaged or scratched.

### BACKGROUND OF THE INVENTION

### Field of the Invention

The present invention relates to a wipe cloth structure, in particular to a sticky wipe cloth structure.

### Description of Related Art

The air in the human living environment is full of various suspended particles such as soil dust, industrial waste gas, pollen, dander, etc. These suspended particles are not only prone to respiratory disease, but also to attachment to various objects around life. In order to maintain the cleanliness and comfort of the living environment and the normal operation of precision machines, these suspended particles must be wiped and removed in time.

The common wiping cloth is woven into a cloth through fiber yarn and then cut and sewn. However, after wiping, this type of wiping cloth tends to fall off because of its own fiber, yarn, and cotton wool. Although dust and dirt have been removed on the surface of the wiped object, the cotton wool is still attached, and the surface of the object cannot be wiped clean. Therefore, the existing conventional wiping cloth cannot be used to wipe related items in the fields of electronics, medical, aerospace and other fields that have zero tolerance for dust.

At present, the inventor has developed a sticky wipe cloth structure based on years of rich design, development and actual production experience in this related industry to improve the problem of cotton wool falling off conventional wipers, and to achieve better practical value.

### SUMMARY OF THE INVENTION

A main object of the present invention is to provide a sticky wipe cloth structure, especially a wipe cloth structure with adhesive that can actually adhere to dust without dropping cotton wool.

The main objects and effects of the sticky wipe cloth structure of the present invention are achieved by the following specific technical means.

A sticky wipe cloth structure mainly comprises a cloth layer and an acrylate polymer adhesive layer, wherein the acrylate polymer adhesive layer is formed on a surface of the cloth layer.

The acrylate polymer adhesive layer penetrates into fibers of the cloth layer.

The cloth layer is made of anti-static cloth.

The acrylate polymer adhesive layer is an anti-static adhesive layer.

Raw material of the acrylate polymer adhesive layer is selected from acrylate polymers.

The acrylate polymer adhesive layer is attached on the surface of the cloth layer in a spraying or a dipping manner.

The surface of the cloth layer is one of an upper surface or a lower surface of the cloth layer or a combination thereof.

### BRIEF DESCRIPTION OF THE DRAWINGS

FIG. 1 is an enlarged sectional view of a acrylate polymer adhesive layer of a sticky wipe cloth of the present invention formed on a surface of a cloth layer by spraying.

FIG. 2 is an enlarged sectional view of a acrylate polymer adhesive layer of a sticky wipe cloth of the present invention formed on a surface of a cloth layer by dipping.

### DETAILED DESCRIPTION OF THE PREFERRED EMBODIMENT

In order to have a more complete and clear disclosure of the technical content used in the present invention, the purpose of the invention and the effect achieved, the present invention is described in detail below, referring to the disclosed drawings and drawing numbers:

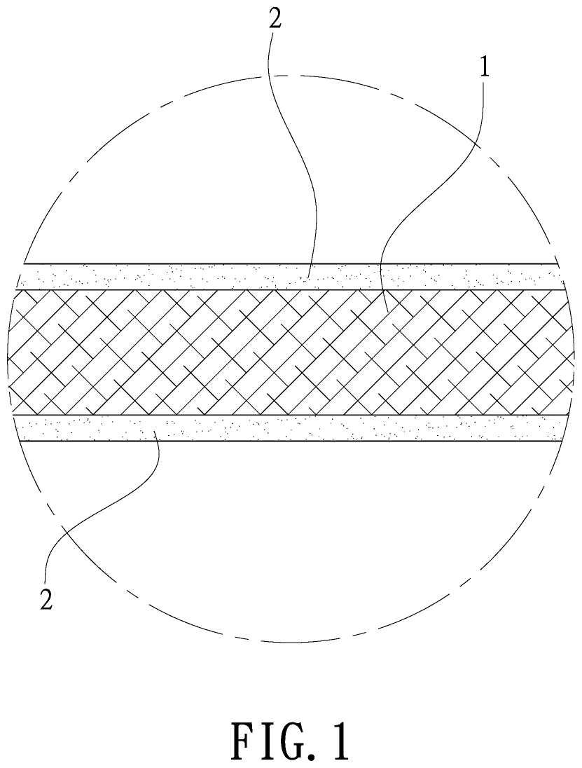

First, referring to FIG. 1, a partial enlarged sectional view of a sticky wipe cloth structure of a first preferred embodiment of the present invention is illustrated.

The sticky wipe cloth structure of the present invention mainly includes a cloth layer 1 and an acrylate polymer adhesive layer 2; wherein the cloth layer 1 is formed by weaving fibers,

wherein the acrylate polymer adhesive layer 2 is composed of acrylate polymer, and is formed on a surface of the cloth layer 1. According to the embodiment disclosed in FIG. 1, the acrylate polymer adhesive layer 2 is attached and formed on the surface of the cloth layer 1 by spraying.

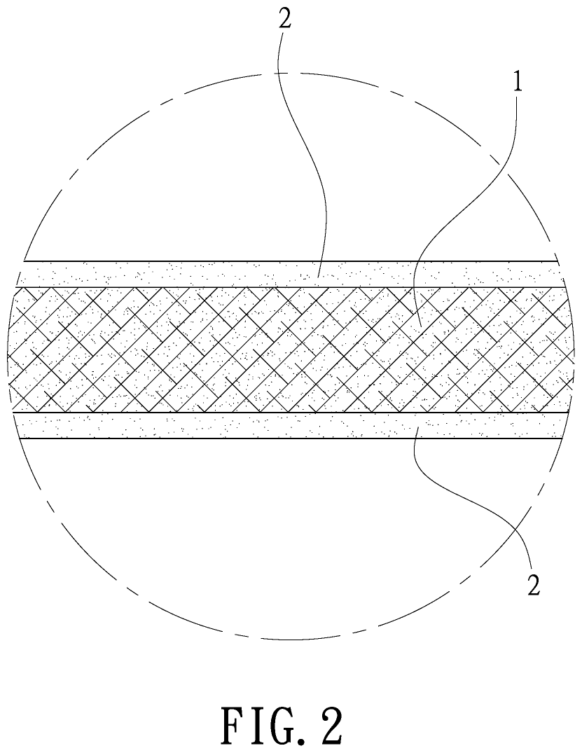

Referring to FIG. 2, a partial enlarged sectional view of a sticky wipe cloth structure of another preferred embodiment of the present invention is illustrated. The difference between this embodiment and the first embodiment disclosed in FIG. 1 is that the acrylate polymer adhesive layer 2 is attached and formed on the surface of the cloth layer 1 by dipping, and penetrates into the fibers of the cloth layer 1.

According to the embodiment disclosed in the above-mentioned FIG. 1 and FIG. 2, the acrylate polymer adhesive layer 2 is formed on the surface of the cloth layer 1, wherein the surface is one of an upper surface or a lower surface of the cloth layer 1 or a combination thereof.

In one of the preferred embodiments of the present invention, the cloth layer 1 is made of anti-static cloth, so that the finished product of the sticky wipe cloth of the present invention has an anti-static effect.

In one of the preferred embodiments of the present invention, the acrylate polymer adhesive layer 2 is provided with an anti-static component, so that the finished product of the sticky wipe cloth of the present invention has an anti-static effect.

The sticky wipe cloth of the present invention is allowed to be used in wiping electronic products (such as substrates) and objects of any kinds to be wiped in the fields of automobiles, airplanes, aviation, medical treatment, semiconductors, optoelectronics, electronic equipment, precision instruments, household cleaning, etc. . . . The acrylate polymer adhesive layer 2 on the surface of the cloth layer 1 has stickiness. When wiping the surface of the object, the acrylate polymer adhesive layer 2 will stick and attract the dust, particles . . . and other dirt on the surface of the object, so as to remove the dust, particles . . . and other dirt on the surface of the object, and ensure that the surface of the object is not damaged or scratched.

What is claimed is:

1. A sticky wipe cloth structure, mainly comprising: a cloth layer and an acrylate polymer adhesive layer, wherein the acrylate polymer adhesive layer is formed on a surface of the cloth layer.

2. The sticky wipe cloth structure as claimed in claim 1, wherein the surface is one of an upper surface or a lower surface of the cloth layer or a combination thereof.

3. The sticky wipe cloth structure as claimed in claim 2, wherein the cloth layer is made of anti-static cloth.

4. The sticky wipe cloth structure as claimed in claim 1, wherein the acrylate polymer adhesive layer is formed on the surface of the cloth layer in a spraying or a dipping manner.

5. The sticky wipe cloth structure as claimed in claim 4, wherein the acrylate polymer adhesive layer is an anti-static adhesive layer.

6. The sticky wipe cloth structure as claimed in claim 1, wherein when the acrylate polymer adhesive layer is formed in a dipping manner, the acrylate polymer adhesive layer penetrates into fibers of the cloth layer.

7. The sticky wipe cloth structure as claimed in claim 5, wherein the acrylate polymer adhesive layer is an anti-static adhesive layer.

8. The sticky wipe cloth structure as claimed in claim 1, wherein the acrylate polymer adhesive layer is an anti-static adhesive layer.

9. The sticky wipe cloth structure as claimed in claim 2, wherein the acrylate polymer adhesive layer is formed on the surface of the cloth layer in a spraying or a dipping manner.

10. The sticky wipe cloth structure as claimed in claim 9, wherein the acrylate polymer adhesive layer is an anti-static adhesive layer.

11. The sticky wipe cloth structure as claimed in claim 2, wherein when the acrylate polymer adhesive layer is formed in a dipping manner, the acrylate polymer adhesive layer penetrates into fibers of the cloth layer.

12. The sticky wipe cloth structure as claimed in claim 11, wherein the acrylate polymer adhesive layer is an anti-static adhesive layer.

13. The sticky wipe cloth structure as claimed in claim 2, wherein the acrylate polymer adhesive layer is an anti-static adhesive layer.

14. The sticky wipe cloth structure as claimed in claim 3, wherein the acrylate polymer adhesive layer is formed on the surface of the cloth layer in a spraying or a dipping manner.

15. The sticky wipe cloth structure as claimed in claim 14, wherein the acrylate polymer adhesive layer is an anti-static adhesive layer.

16. The sticky wipe cloth structure as claimed in claim 3, wherein when the acrylate polymer adhesive layer is formed in a dipping manner, the acrylate polymer adhesive layer penetrates into fibers of the cloth layer.

17. The sticky wipe cloth structure as claimed in claim 16, wherein the acrylate polymer adhesive layer is an anti-static adhesive layer.

18. The sticky wipe cloth structure as claimed in claim 3, wherein the acrylate polymer adhesive layer is an anti-static adhesive layer.
